(19) United States
(12) Patent Application Publication
(10) Pub. No.: US 2011/0303797 A1
(43) Pub. Date: Dec. 15, 2011

(54) POWER POLE EXTENDER

(75) Inventors: Allison Daub, Madison, CT (US); John DiBenedetto, Raynham, MA (US); Dan Laurinitis, Andover, CT (US); Sean Urquhart, West Hartford, CT (US)

(73) Assignee: The Wiremold Company, West Hartford, CT (US)

(21) Appl. No.: 13/098,804

(22) Filed: May 2, 2011

Related U.S. Application Data
(60) Provisional application No. 61/330,732, filed on May 3, 2010.

(51) Int. Cl. F16L 3/123; F16L 3/08

(52) U.S. Cl. 248/49

(57) ABSTRACT

A power pole extender for extending the length of a base power pole includes a housing having a central divider separating a first channel within the housing from a second channel within the housing. The power pole extender interfaces with the base power pole such that the first and second channels communicate with power and communication channels of the base power pole, respectively, allowing power and communication wiring to extend therethrough. The power pole extender includes a first support sleeve partially disposed within the first channel and extending outwardly therefrom and a second support sleeve partially disposed within the second channel and extending outwardly therefrom. The first and second support sleeves provide structural support to the interface between the power pole extender and the base power pole. The power pole extender may be secured to the base power pole by a detachable clip.

### CROSS-REFERENCE TO RELATED APPLICATIONS

This application claims priority to U.S. Provisional Patent Application No. 61/330,732, filed May 3, 2010, which is hereby incorporated by reference in its entirety.

### FIELD OF THE INVENTION

The present invention relates to power poles and, more particularly, to devices and methods for varying power pole length.

### BACKGROUND OF THE INVENTION

A power pole is a vertical structure that brings power and communication wiring from an overhead source down to an isolated area. Power poles are typically used in office buildings, warehouses, stores and other similar facilities where power and communication wiring is desired.

Conventional power poles include a central divider disposed between outer covers to form a communication channel and a power channel within the outer covers, the communication channel and the power channel being separated from one another by the central divider. The bottom of the power pole has cut-outs for power and communication receptacles to facilitate connection to external devices. Low voltage communication wiring typically extends from the communication receptacles through the communication channel and high voltage power wiring extends from the power receptacles through the power channel. Thus, the central divider usually isolates the communication wiring from the power wiring within the power pole, limiting accessibility to the high voltage wiring.

The length of a conventional power pole typically depends on the height of the overhead source where the power pole is to be employed. For example, conventional power poles may be fabricated to predetermined lengths of ten feet, twelve feet and fifteen feet to match ceiling heights of ten feet, twelve feet and fifteen feet, respectively. However, this predetermined fabrication allows only minimal flexibility in changing placement of the power pole, since the ceiling height must remain the same. Additionally, due to their large lengths, conventional power poles must be freight shipped, which results in relatively long shipping times and oftentimes results in damage to the power pole. Thus, power pole manufactures incur additional expenses and must take added precautions to preemptively reduce this shipping damage.

Accordingly, there is a need for a power pole extender that overcomes the deficiencies of the prior art by allowing the length of power poles to be changed.

### SUMMARY OF THE INVENTION

According to the present invention, a power pole extender extends the length of a base power pole. The power pole extender includes a housing having a central divider separating a first channel within the housing from a second channel within the housing. The power pole extender interfaces with the base power pole such that the first and second channels communicate with power and communication channels of the base power pole, respectively, allowing power and communication wiring to extend therethrough. The power pole extender includes a first support sleeve partially disposed within the first channel and extending outwardly therefrom and a second support sleeve partially disposed within the second channel and extending outwardly therefrom. The first and second support sleeves provide structural support to the interface between the power pole extender and the base power pole. The power pole extender may be secured to the base power pole by a detachable clip. In some embodiments, the detachable clip may engage a locking element on the central divider.

According to one embodiment, the locking element is a bolt and the detachable clip includes a lock slot for engaging the locking element to prevent relative movement between the power pole extender and the base power pole.

According to another embodiment, the locking element has a gumdrop shape and the lock slot is a variable sized slot to substantially eliminate relative movement between the power pole extender and the base power pole when engaged.

According to the present invention, the detachable clip may include elevated edges for slidably engaging a base divider of the base power pole and an alignment edge for assisting with positioning the detachable clip on the base divider. The detachable clip may also include a ramp to ensure that the detachable clip slides over the locking element.

According to another embodiment of the present invention, a plurality of power pole extenders may be connected to the base power pole to achieve a desired power pole length.

These and other objects, features and advantages of the present invention will become apparent in light of the following detailed description of non-limiting embodiments, with reference to the accompanying drawings.

### BRIEF DESCRIPTION OF THE DRAWINGS

FIG. 1 is a perspective view of a power pole extender connected to a base power pole according to an embodiment of the present invention;

FIG. 2 is a perspective view of the base power pole of FIG. 1;

FIG. 3 is an enlarged cross-sectional view of the base power pole of FIG. 2;

FIG. 4 is a perspective view of the power pole extender of FIG. 1;

FIG. 5 is an enlarged cross-sectional view of the power pole extender of FIG. 4;

FIG. 6 is a perspective view of the power pole extender and the base power pole of FIG. 1 prior to connection exposing a detachable clip;

FIG. 7 is an enlarged cross-sectional view of the base power pole of FIG. 6;

FIG. 8 is a partially exploded perspective view of the base power pole of FIG. 2 with the removable cover being removed;

FIG. 9 is a plan view of a portion of the base power pole with the detachable clip of FIG. 6 attached thereto;

FIG. 10 is a partial side view of the power pole extender and base power pole of FIG. 1 during assembly;

FIG. 11 is a partial side view of the power pole extender and base power pole of FIG. 1 during assembly;

FIG. 12 is a partial side view of the power pole extender and base power pole of FIG. 1 during assembly;

FIG. 13 is a cross-sectional view of a portion of an interface between the power pole extender and the base power pole of FIG. 1;

FIG. 14 is a side view of the base power pole and power pole extender of FIG. 1 with a second detachable clip connected thereto;

FIG. 15 is a side view of a plurality of power pole extenders attached to a base power pole according to another embodiment of the present invention;

FIG. 16 is a partially cutaway perspective view of the interface between a central divider of the power pole extender and a base divider of the base power pole according to another embodiment of the present invention;

FIG. 17 is a partially cutaway perspective view of the interface between a central divider of the power pole extender and a base divider of the base power pole according to another embodiment of the present invention;

FIG. 18 is a perspective view of the power pole extender according to another embodiment of the present invention;

FIG. 19 is a perspective view of another embodiment of the detachable clip for use with the power pole extender of FIG. 18;

FIG. 20 is a perspective view of the power pole extender of FIG. 18 being connected to the base power pole;

FIG. 21 is a perspective view of the fully assembled power pole extender and base power pole of FIG. 19;

FIG. 22A is a perspective view of the power pole extender according to another embodiment of the present invention;

FIG. 22B is an exploded view of the power pole extender of FIG. 22A;

FIG. 23 is top perspective view of a first support sleeve of the power pole extender of FIG. 22A;

FIG. 24 is a top perspective view of a second support sleeve of the power pole extender of FIG. 22A;

FIG. 25 is a top perspective view of the detachable clip of the power pole extender of FIG. 22A;

FIG. 26 is a front end view of the power pole extender of FIG. 22A;

FIG. 27A is a partial side view of the power pole extender of FIG. 22A and the base power pole during assembly;

FIG. 27B is a partial side view of the power pole extender of FIG. 22A and the base power pole during assembly; and

FIG. 27C is a partial side view of the power pole extender of FIG. 22A and the base power pole after assembly.

### DETAILED DESCRIPTION OF A PREFERRED EMBODIMENT

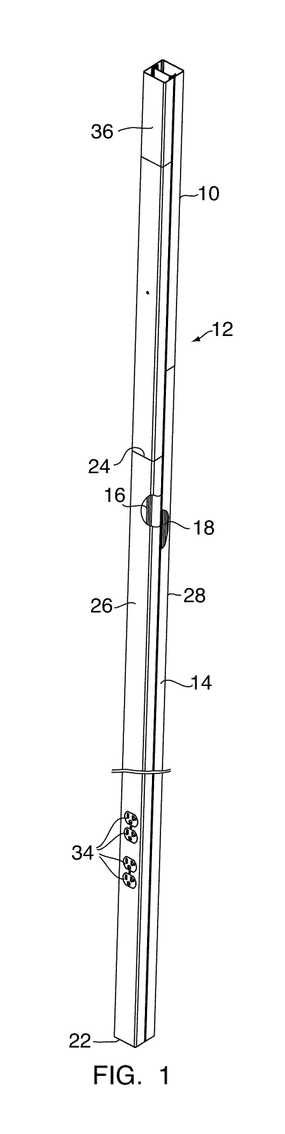

Referring to FIG. 1, a power pole extender 10 in accordance with the present invention forms an interface 12 with a base power pole 14 to extend the length of the base power pole 14, thereby allowing power and communication wiring 16 and 18 to be run from an overhead source, such as a ceiling, to a desired location below, such as a desk or workstation. The power pole extender 10 is able to extend the length of a variety of known standard base power poles 14, such as those manufactured by The Wiremold Company, having a place of business at 60 Woodlawn St., West Hartford, Conn. 06110.

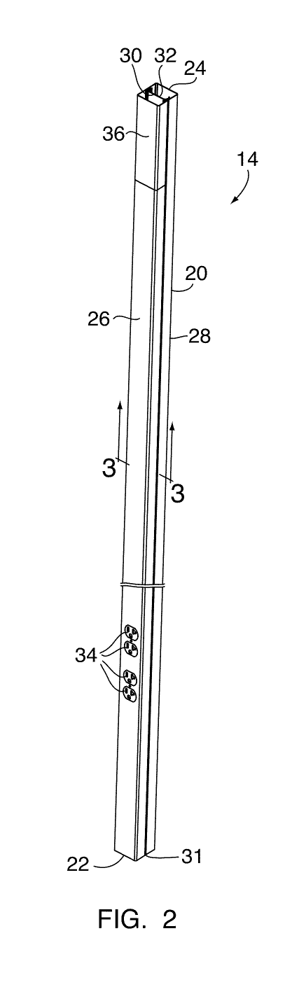

Referring to FIG. 2, the base power pole 14 typically includes a housing 20 extending longitudinally from a lower end 22 to an upper end 24. The housing may include a power cover 26 and a communication cover 28 attached to opposing sides of a base divider 30. The base divider 30 extends from a lower edge 31 disposed at the lower end 22 of the base power pole 14 to a top edge 32 located approximately at the upper end 24 of the base power pole 14. The base power pole 14 includes receptacles 34, located in the vicinity of the lower end 22 to facilitate connection of external devices (not shown). Additionally, the power cover 26 typically includes a removable cover 36 located at the upper end 24 that is approximately eight inches (8 in.) in length.

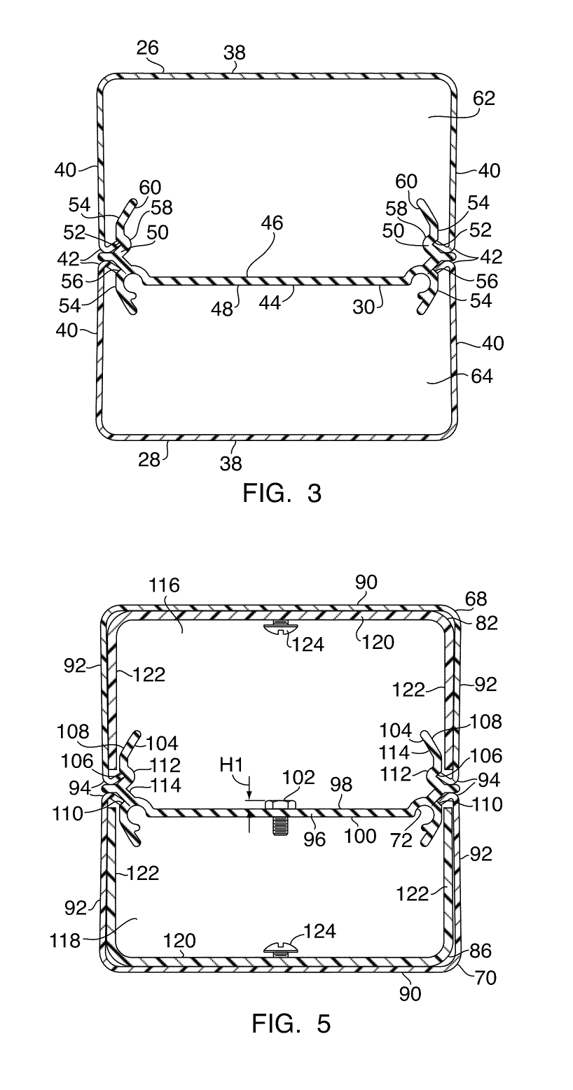

Referring to FIG. 3, the power cover 26 and the communication cover 28 are each formed with an outer wall 38 attached to two substantially perpendicular side walls 40. The side walls 40 include attachment hooks 42 at the ends opposite the outer wall 38 to facilitate attachment to the base divider 30. The base divider 30 includes a substantially flat center wall 44 having a power side 46 and a communication side 48. The center wall 44 is flanked by side portions 50, each of which includes a first engagement groove 52 formed on an outer surface 54 for accommodating the attachment hooks 42 of the power cover 26 and a second engagement groove 56, also formed on the outer surface 54, for accommodating the attachment hooks 42 of the communication cover 28. Each side portion 50 also includes a retaining ridge 58 located substantially opposite the first engagement groove 52 on an inner surface 60 of the side portion 50.

The attachment hooks 42 of the power cover 26 engage the first engagement grooves 52 of the base divider 30, preferably in a snap fit, to define a power channel 62 bounded by the power cover 26 and the power side 46 of the base divider 30. Similarly, the attachment hooks 42 of the communication cover 28 engage the second engagement grooves 56 of the base divider 30, also preferably in a snap fit connection, to define a communication channel 64 bounded by the communication cover 28 and the communication side 48 of the base divider 30. The power channel 62 and the communication channel 64 run longitudinally through the base power pole 14 from the upper end 24 to the lower end 22, shown in FIG. 2, to accommodate the power and communication wiring 16 and 18, shown in FIG. 1.

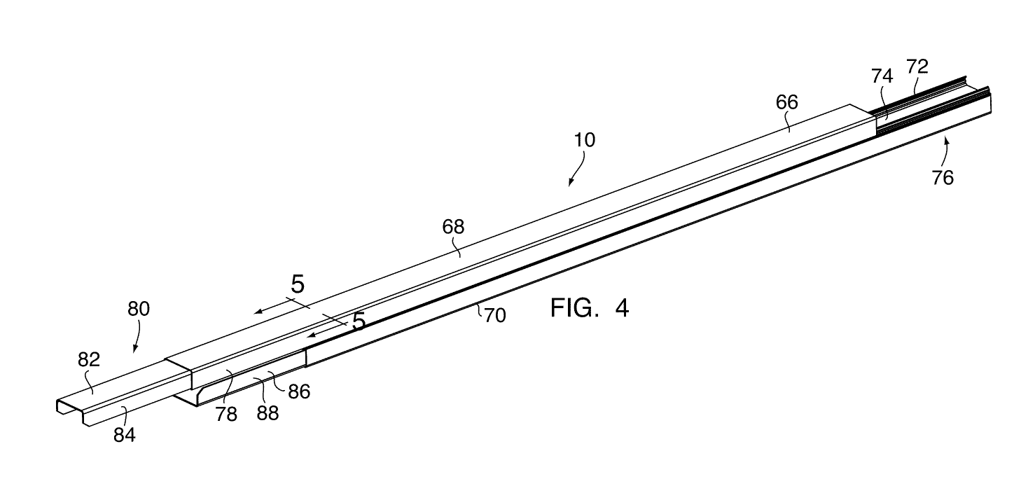

Referring to FIG. 4, the power pole extender 10 includes a housing 66 having a first cover 68 and a second cover 70 connected to opposing sides of a central divider 72. The first cover 68, second cover 70 and central divider 72 are all substantially the same length. However, the first cover 68 is offset from the second cover 70 and the central divider 72, exposing a first end portion 74 of the central divider 72 at a first end 76 of the power pole extender 10. The offset causes a second end portion 78 of the first cover 68 to extend beyond the central divider 72 and second cover 70 at a second end 80 of the power pole extender 10. The first cover 68 is preferably offset from the second cover 70 and the central divider 72 by approximately eight inches (8 in.). The eight inch (8 in.) offset is advantageous because it allows the removable cover 36, shown in FIG. 2, which has a standard length of eight inch (8 in.), to be exploited as discussed below.

The power pole extender 10 also includes a first support sleeve 82, which is partially accommodated within the first cover 68 and extends outwardly therefrom at the second end 80 of the power pole extender 10 to define a first support sleeve portion 84. The power pole extender 10 also includes a second support sleeve 86, which is partially accommodated within the second cover 70 and extends outwardly therefrom at the second end 80 of the power pole extender 10 to define a second support sleeve portion 88. Preferably, the first and second support sleeves 82 and 86 are each approximately eighteen inches (18 in.) long with approximately six inches (6 in.) of the eighteen inches (18 in.) of length extending outwardly from the first and second covers 68 and 70, respectively, to define the first and second support sleeve portions 84 and 88. Preferably, the power pole extender 10 is fabricated from aluminum or steel to satisfy national electrical codes and UL requirements, however, the power pole extender 10 may also be formed from other rigid materials known in the art, such as plastic.

Referring to FIG. 5, similar to the power and communication covers 26 and 28 of the base power pole 14, shown in FIG. 3, the first cover 68 and the second cover 70 of the power pole extender 10 are each formed with an outer wall 90 attached to two substantially perpendicular side walls 92. The side walls 92 include attachment hooks 94 at the ends opposite the outer wall 90 to facilitate attachment to the central divider 72. The central divider 72 is also formed to have substantially the same cross-section as the cross-section of a base divider 30 of the base power pole 14, shown in FIG. 3. Specifically, the central divider 72 includes a substantially flat center wall 96 having a power side 98 and a communication side 100. The center wall 96 of the central divider 72 includes a locking element 102, such as a bolt, having a retaining height H1, which will be discussed in more detail below. The center wall 96 is flanked by side portions 104, each of which includes a first engagement groove 106 on its outer surface 108 for accommodating the attachment hooks 94 of the first cover 68 and a second engagement groove 110, also on the outer surface 108, for accommodating the attachment hooks 94 of the second cover 70. Each side portion 104 also includes a retaining ridge 112 located substantially opposite the first engagement groove 106 on an inner surface 114 of the side portion 104.

The attachment hooks 94 of the first cover 68 engage the first engagement grooves 106 of the central divider 72, preferably in a snap fit connection, to define a first channel 116 bounded by the first cover 68 and the power side 98 of the central divider 72. Similarly, the attachment hooks 94 of the second cover 70 engage the second engagement grooves 110 of the central divider 72, also preferably in a snap fit connection, to define a second channel 118 bounded by the second cover 70 and the communication side 100 of the central divider 72. The first channel 116 and the second channel 118 run longitudinally through the power pole extender 10 so that the power and communication wiring 16 and 18, shown in FIG. 1, may be run therethrough.

The first and second support sleeves 82 and 86 each include an outer wall 120 connected to two substantially perpendicular side walls 122. The first and second support sleeves 82 and 86 are fabricated to be smaller than the first and second covers 68 and 70 so that they fit within the first and second channels 116 and 118 by slidably engaging the outer wall 90 and side walls 92 of the first and second covers 68 and 70. The first and second support sleeves 82 and 86 are attached to the first and second covers 68 and 70, respectively, by screws 124 or similar fastening means known in the art, such as welding or a press fit.

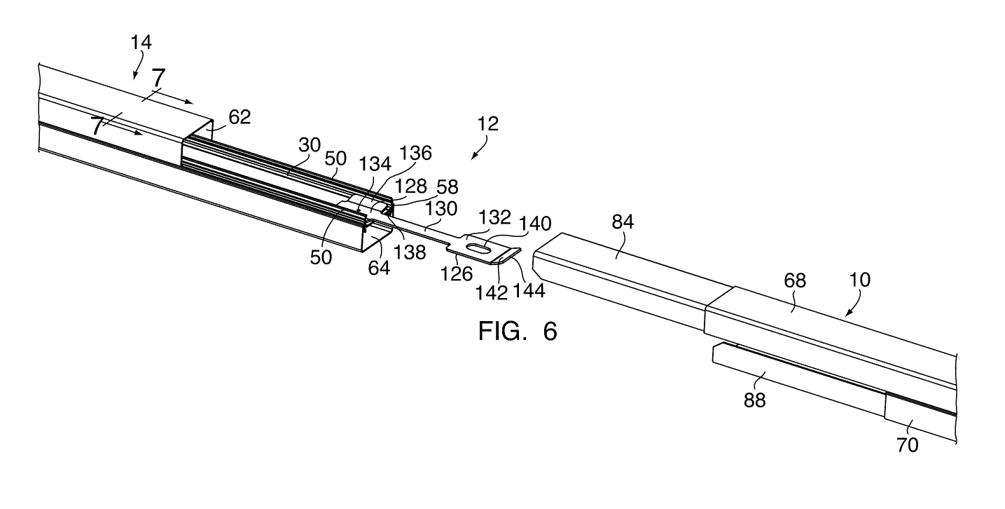

Referring to FIG. 6, the first and second support sleeve portions 84 and 88, extending outwardly from the first and second covers 68 and 70, respectively, are configured to be inserted into the power and communication channels 62 and 64 of the base power pole 14, to add support to the interface 12, as will be discussed in more detail below. The interface 12 between the power pole extender 10 and the base power pole 14 is maintained by a detachable clip 126 having a base portion 128, a flexible body 130 and an engagement portion 132. The detachable clip 126 is attached to the base divider 30 of the base power pole 14 by a set screw 134 or similar fastening means prior to connecting the power pole extender 10 to the base power pole 14, as will be discussed in more detail below.

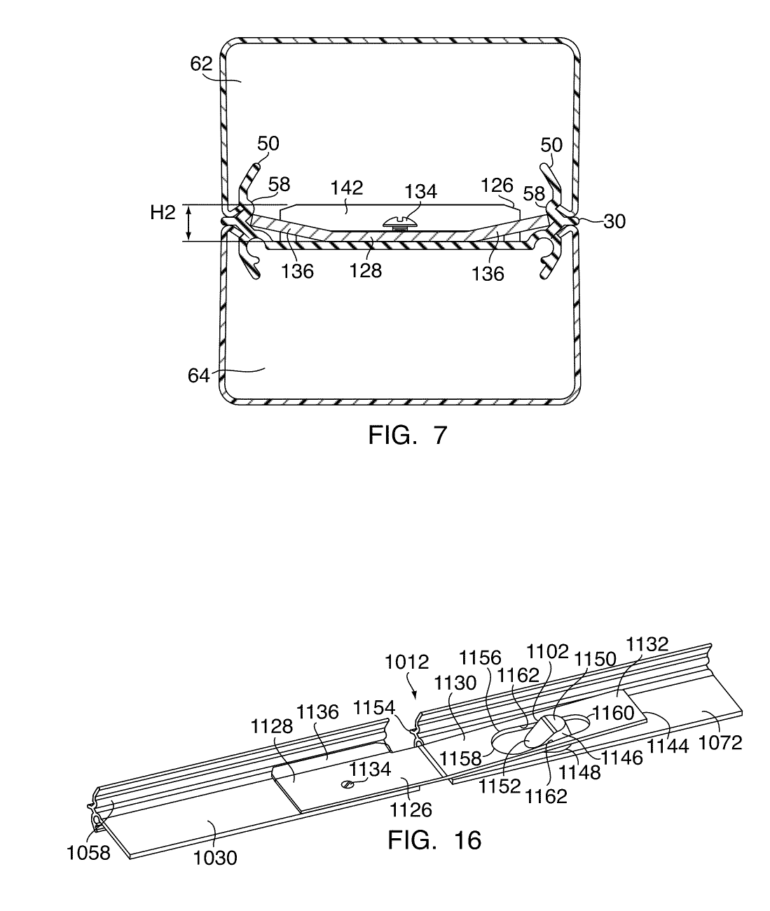

Referring to FIGS. 6 and 7, the base portion 128 of the detachable clip 126 includes elevated side edges 136 and an alignment edge 138. The elevated edges 136 are configured to slide into the retaining ridges 58 of side portions 50 of the base divider 30 to facilitate the connection between the detachable clip 126 and the base divider 30.

The flexible body 130 extends outwardly from the alignment edge 138 of the base portion 128 to the engagement portion 132. The flexible body 130 is formed with a width that is less than that of the base portion 128 or the engagement portion 132 so that the flexible body 130 may elastically deform to allow the engagement portion 132 to pass over the locking element 102 of the power pole extender 10, shown in FIG. 5, as will be discussed in more detail below.

The engagement portion 132 includes a central lock slot 140 and a ramp 142, at its distal end 144, for engaging the locking element 102, shown in FIG. 5, as will be discussed in more detail below. The ramp 142 is formed to have a ramp height H2 that is greater than the retaining height H1, shown in FIG. 5, of the locking element 102 to ensure that the detachable clip 126 engages the locking element 102, as will be discussed in more detail below. The ramp height H2 is preferably formed to be only slightly larger than the retaining height H1 of the locking element 102, for example, the bolt head in FIG. 5, so that the detachable clip 126 engages the locking element 102 without occupying a large portion of first channel 116, shown in FIG. 5, once engaged. Preferably, the detachable clip 126 is fabricated from aluminum or steel to satisfy national electrical codes and UL requirements, however, the detachable clip 126 may also be formed from other rigid materials known in the art, such as plastic.

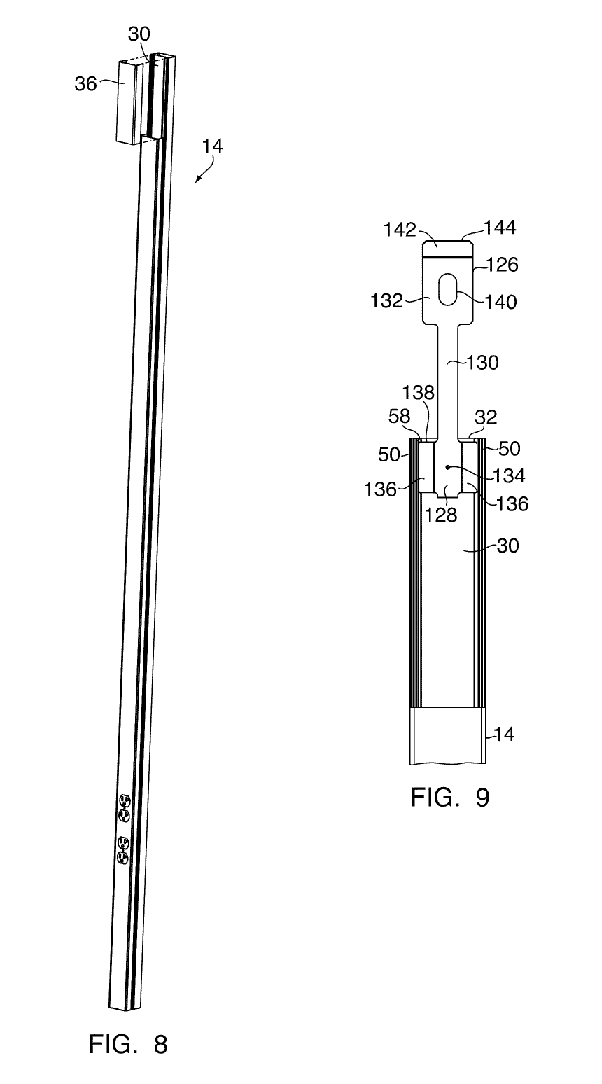

In operation, referring to FIG. 8, to install the power pole extender 10 on the base power pole 14, the removable cover 36 is first removed from the base power pole 14. The removable cover 36 may be snapped or slid off of the base divider 30, as should be understood by those skilled in the art.

Referring to FIG. 9, the detachable clip 126 is then slid into the retaining ridges 58 of the side portions 50 of the base divider 30, which is exposed due to the removal of the removable cover 36. The detachable clip 126 is slid into the base divider 30 until the alignment edge 138 of the base portion 128 is approximately flush with the top edge 32 of the base divider 30. The detachable clip 126 is then secured in place by the set screw 134.

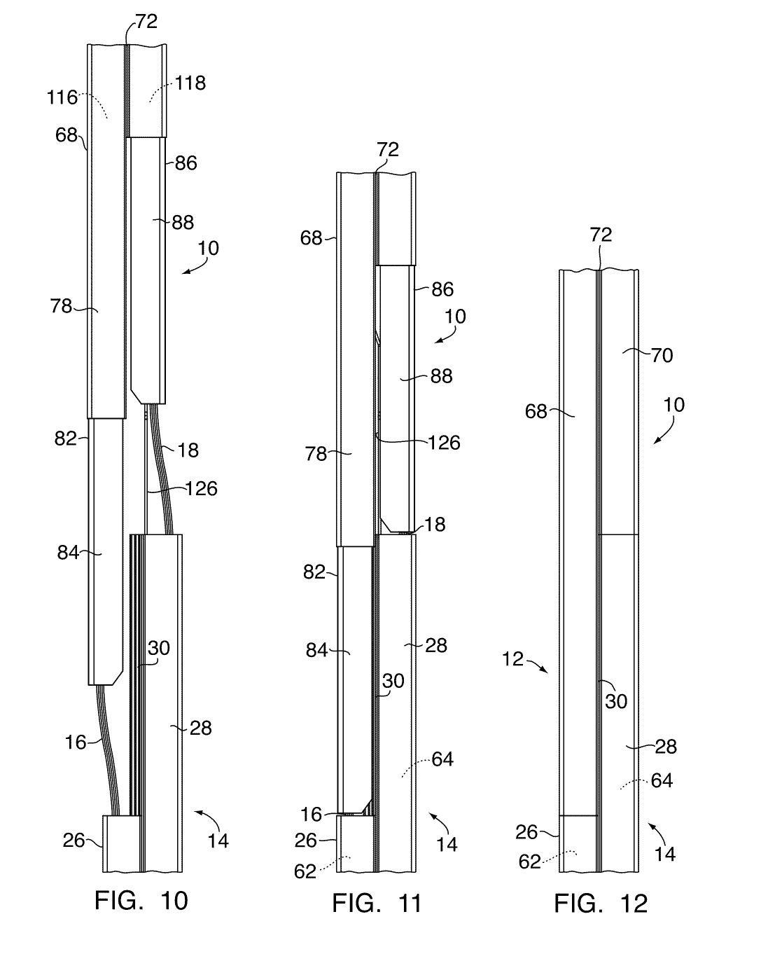

Referring to FIG. 10, the power pole extender 10 is moved proximate to the base power pole 14 so that power wiring 16 and/or communication wiring 18 may be snaked from the base power pole 14 through the first and second channels 116 and 118 of power pole extender 10, respectively. However, if desired, as an alternative, the power wiring 16 and/or communication wiring 18 may be snaked after connection of the power pole extender 10 and the base power pole 14.

Referring to FIG. 11, the offset second end portion 78 of the first cover 68 of the power pole extender 10 may be partially snapped on to the base divider 30 of the base power pole 14 so that the attachment hooks 94, shown in FIG. 5, of the first cover 68 engage the engagement grooves 52 of the base divider 30, shown in FIG. 3.

Referring to FIG. 12, the power pole extender 10 is then slid toward the base power pole 14 with the first and second support sleeves 82 and 86 sliding into the power and communication channels 62 and 64, shown in FIG. 7, of the base power pole 14, respectively. Once the first cover 68, second cover 70 and central divider 72 of the power pole extender 10 are flush with the power cover 26, communication cover 28 and base divider 30 of the base power pole 14, respectively, the detachable clip 126, shown in FIGS. 9-11, locks the power pole extender 10 to the base power pole 14, as will be discussed in more detail below. The removable cover 36 may be snapped onto the exposed first end portion 74, shown in FIG. 4, of the power pole extender 10 to complete the installation, as shown in FIG. 1.

The first and second support sleeves 82 and 86, shown in FIG. 11, extend into both the power pole extender 10 and the base power pole 14, providing structural support to the interface 12 such that the extended power pole has approximately the same strength as currently manufactured continuous power poles. Preferably, the interface 12 between the power pole extender 10 and the base power pole 14 has at least approximately ninety percent (90%) of the effective strength of a continuous power pole.

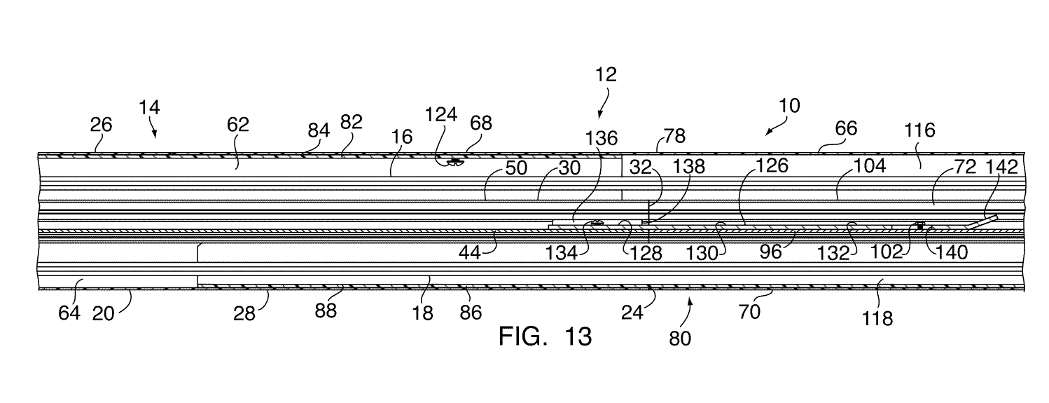

Referring to FIG. 13, a more detailed view of the interface between the base power pole 14 and the power pole extender 10 is shown. As the power pole extender 10 is slid onto the base power pole 14, as discussed above in connection with FIG. 12, the ramp 142 contacts the locking element 102. Since the ramp height H2, shown in FIG. 7, is greater than the retaining height H1, shown in FIG. 5, of the locking element 102, the ramp 142 begins to pass over the locking element 102. The flexible body 130 flexes to allow the engagement portion 132 of the detachable clip 126 to deflect upward and pass over the locking element 102. As the power pole extender 10 and base power pole 14 are moved closer to one another, the locking element 102 engages the lock slot 140 and the engagement portion 132 of the detachable clip 126 snaps downward into place, with the locking element 102 being captured within the lock slot 140. Preferably, the power pole extender 10 is configured to be flush with the base power pole 14 when the locking element 102 engages the lock slot 140. The engagement between the locking element 102 and the lock slot 140 prevents the power pole extender 10 and the base power pole 14 from separating, which could lead to exposed wiring or falling components that could result in injury and/or death. Additionally, the detachable clip 126 may also serve to prevent assembly error by making an audible click as the engagement portion 132 snaps downward into place, indicating that the locking element 102 is engaged within the lock slot 140.

Since the detachable clip 126 prevents separation of the power pole extender 10 and the base power pole 14, relative movement between the base power pole 14 and the power pole extender 10 is substantially prevented. The lock slot 140 may be fabricated with tolerances to ensure engagement with the locking element 102 even when the detachable clip 126 is only roughly installed in the correct position, i.e. the alignment edge 138 is not precisely aligned with the top edge 32 of the base divider 30, as seen in FIG. 9. The manufacturing tolerances may result in a slight relative movement between the power pole extender 10 and the base power pole 14, which is preferably no more than sixty-five hundredths of an inch (0.65 in.).

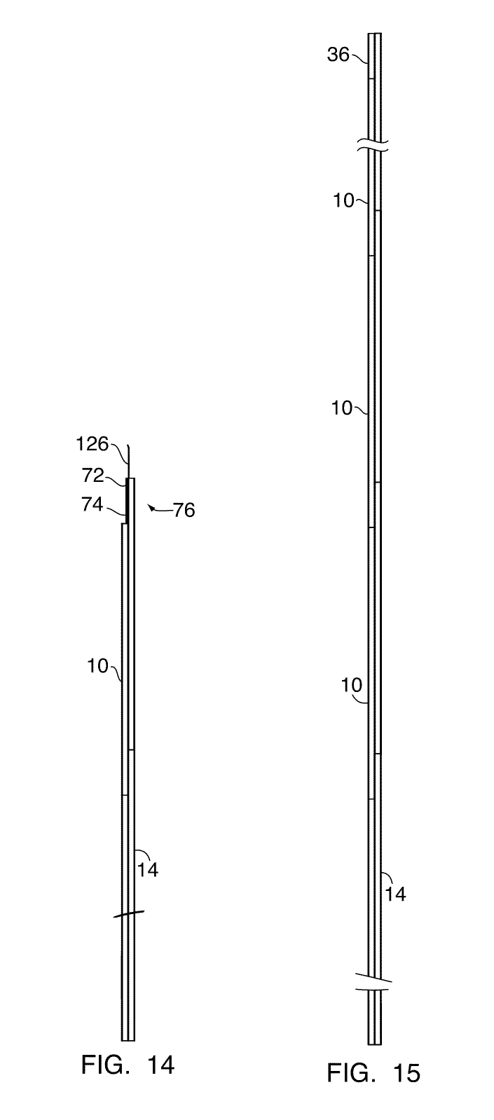

Referring to FIG. 14, multiple power pole extenders 10 may be attached to a single base power pole 14, extending the power pole to an even greater desired height than the single power pole extender 10 is capable of achieving. The additional power pole extenders 10 are attached in substantially the same manner described in connection with FIGS. 9-13. Specifically, the first power pole extender 10 is attached to the base power pole 14 as discussed in connection with FIG. 9-13, except that the removable cover 36 is not snapped onto the exposed first end portion 74 of the first power pole extender 10. Instead, a second detachable clip 126 is fastened to the central divider 72 of the first power pole extender 10 at the exposed first end portion 74 according to the same method discussed in connection with FIG. 10. Then, the second power pole extender 10 may be moved proximate to the first power pole extender 10 and power wiring 16 and/or communication wiring 18, shown in FIG. 11, may be snaked through the second power pole extender 10, in the same manner described in connection with FIG. 11. The second power pole extender 10 is then snapped and slid onto the first power pole extender 10 in the same manner discussed in connection with FIGS. 12 and 13. Subsequent power pole extenders 10 may be added according to the same method until the desired height is reached, as seen in FIG. 15, at which point the removable cover 36 is snapped onto the exposed first end portion 74 of the final power pole extender 10 to complete installation.

Referring to FIG. 16, wherein like numerals represent like elements, an alternate embodiment of the detachable clip 1126 and locking element 1102 is shown. This embodiment substantially eliminates any slight relative movement between the power pole extender (not shown) and the base power pole (not shown), as discussed above, and ensures that the power pole extender (not shown) and base power pole (not shown) are held in a tight interface 1012.

The locking element 1102 has a gumdrop shape with a conical side surface 1146 extending from a base 1148 to a top surface 1150 of the locking element 1102. A front ramp 1152, ascending from the base 1148 to the top surface 1150, is cut into the conical side surface 1146. The locking element 1102 is fastened to the central divider 1072 of the power pole extender (not shown) according to known fastening means, for example, screwing or welding, with the front ramp 1152 facing an interface end 1154 of the central divider 1072 that will interface with the base divider 1030.

The detachable clip 1126 includes base portion 1128, flexible body 1130 and engagement portion 1132. The base portion 1128 and flexible body 1130 are substantially similar to those described in connection with the previous embodiment. The engagement portion 1132 of the detachable clip 1126 includes a variable sized lock slot 1156 for engaging the locking element 1102. The variable sized lock slot 1156 has a first semicircular edge 1158 proximate to the base portion 1128 and a second semicircular edge 1160 proximate the distal end 1144 connected by converging side edges 1162. The diameter of the second semicircular edge 1160 is smaller than the diameter of the first semicircular edge 1158 so that the converging side edges 1162 converge from the first semicircular edge 1158 to the second semicircular edge 1160. Preferably, the first semicircular edge 1158 has a diameter that is slightly larger than the width of the base 1148 of the locking element 1102 and the second semicircular edge 1160 has a diameter that is slightly larger than the width of the top surface 1150 of the locking element 1102.

In operation, the detachable clip 1126 is fastened to the base divider 1030 by the set screw 1134 with the elevated edges 1136 engaging the retaining ridges 1058, in the same manner described above in connection with FIG. 10. Then, as the power pole extender (not shown) is slid onto the base power pole (not shown), as discussed above, the front ramp 1152 forces the distal end 1144 of the engagement portion 1132 of the detachable clip 1126 upward, which is allowed by the flexible body 1130. Once the second semicircular edge 1160 passes over the top surface 1150 of the locking element 1102, the flexible body 1130 allows the engagement portion 1132 of the detachable clip 1126 to partially deflect downward, with the locking element 1102 partially engaging the variable sized lock slot 1156. Due to the variable size of the variable sized lock slot 1156 and the conical side surface 1146 of the locking element 1102, the detachable clip 1126 only partially unbends, with the converging side edges 1162 of the variable sized lock slot 1156 contacting the conical side surface 1146 of the locking element 1102. Once the converging side edges 1162 have engaged the conical side surface 1146, the central and base dividers 1072 and 1030 are prevented from being separated because the act of separation attempts to force the locking element 1102 toward the more narrow second semicircular edge 1160 of the variable sized lock slot 1156. As the central divider 1072 is moved closer to the base divider 1030, the locking element 1102 moves closer to the first semicircular edge 1158, thereby allowing the detachable clip 1126 to further unbend. As the detachable clip 1126 unbends, the converging side edges 1162 move further down the conical side surface 1146, with separation of the central and base dividers 1072 and 1030 still being prevented, as discussed above. Thus, once the central divider 1072 and base divider 1030 are slid to abut one another, even the slight relative movement between the central divider 1072 and the base divider 1030, discussed above, is substantially prevented.

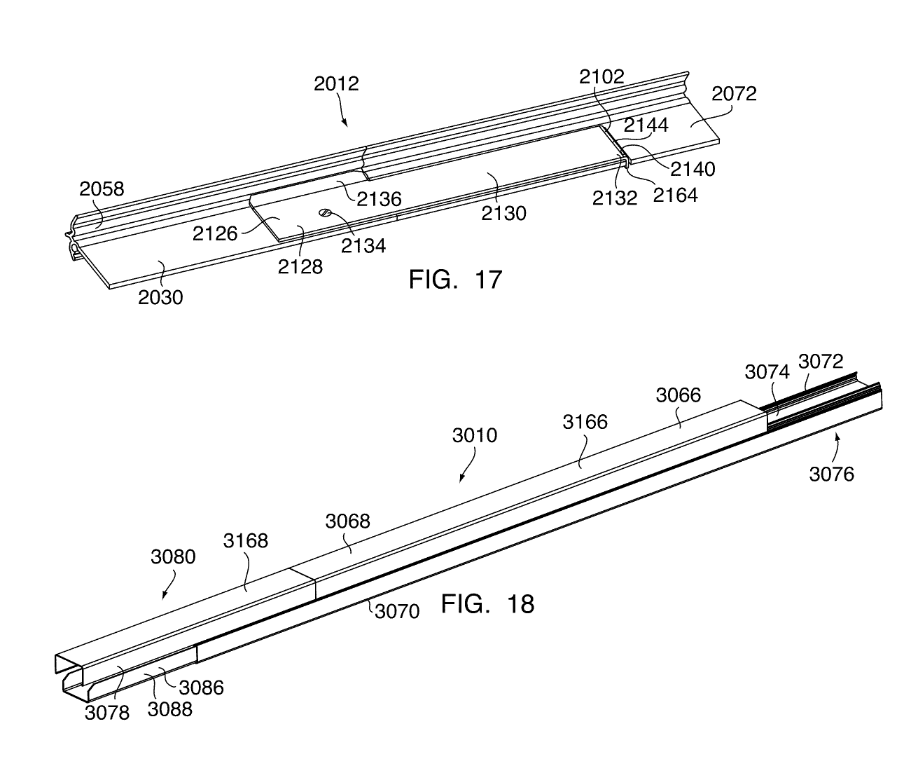

Referring to FIG. 17, an alternate embodiment of the interface 2012 is shown. In this embodiment, the detachable clip 2126 includes base portion 2128, flexible body 2130 and engagement portion 2132. The base portion 2128 and flexible body 2130 are substantially similar to those described in connection with the previous embodiment. However, in this embodiment, the engagement portion 2132 of the detachable clip 2126 includes the locking element 2102, in the form of a downward extending tab 2164 at the distal end 2144 of the engagement portion 2132. Preferably, the tab 2164 is formed to be integral with the detachable clip 2126.

The central divider 2072 includes the lock slot 2140, rather than the locking element, as in the previous embodiments. The lock slot 2140 is formed to be capable of completely accommodating the locking element 2102.

In operation, the detachable clip 2126 is fastened to the base divider 2030 by the set screw 2134 with the elevated edges 2136 engaging the retaining ridges 2058, in the same manner described above in connection with FIG. 10. Then, as the power pole extender (not shown) is slid onto the base power pole (not shown), as discussed above, the flexibly body 2130 flexes upward, allowing the downward extending tab 2164 to pass over the central divider 2072. When the downward extending tab 2164 reaches the lock slot 2140 formed in the central divider 2072, the flexible body 2130 unbends and the detachable clip 2126 snaps downward so that the tab 2164 is accommodated within the lock slot 2140. Preferably, the central divider 2072 is configured to be flush with the base divider 2030 when the downward extending tab 2164 engages the lock slot 2140. The engagement between the tab 2164 and the lock slot 2140 prevents the power pole extender (not shown) and the base power pole (not shown) from separating, which could lead to exposed wiring or falling components that could result in injury and/or death. Additionally, the detachable clip 2126 may also serve to prevent assembly error by making an audible click as the engagement portion 2132 snaps downward into place, indicating that the tab 2164 is engaged within the lock slot 2140.

Referring to FIG. 18, another embodiment of the power pole extender 3010 includes first cover 3068 that is divided into a main body portion 3166 and a detachable end portion 3168. The detachable end portion 3168 is located at the second end 3080 of the power pole extender 3010 and includes second end portion 3078 extending beyond the central divider 3072, as discussed above in connection with the previous embodiments. The detachable end portion 3168 overlaps a portion of the central divider 3072 and is attached to the central divider 3072 in the same manner discussed in connection with the previous embodiments. Preferably, the detachable end portion 3168 overlaps the central divider 3072 over a length of approximately eight inches (8 in.). Additionally, as discussed above, the second end portion 3078 preferably extends approximately eight inches (8 in.) beyond the central divider 3072.

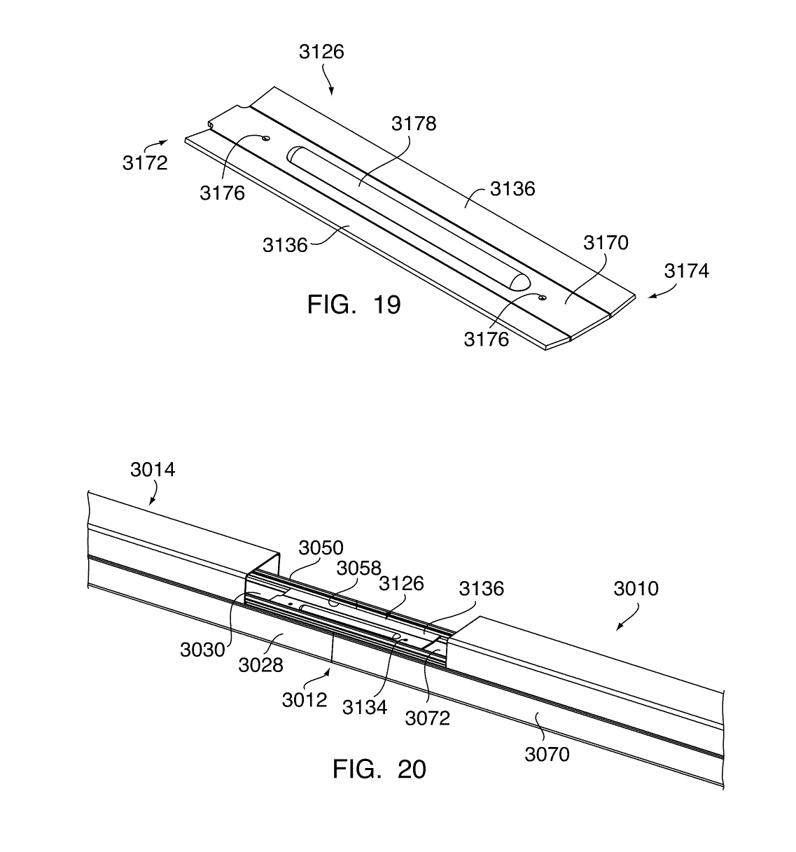

Referring to FIG. 19, the detachable clip 3126 for connecting the power pole extender 3010, shown in FIG. 18, to the base power pole (not shown) has a central body portion 3170 flanked by elevated side edges 3136. The central body portion 3170 and the elevated edges 3136 extend from a base end 3172 to a distal end 3174 of the detachable clip 3126. The central body portion 3170 includes at least two tapped holes 3176, with at least one tapped hole 3176 located proximate to the base end 3172 and at least one tapped hole 3176 located proximate to the distal end 3174. The central body portion 3170 includes a raised structure 3178 located between the at least two tapped holes 3176 for increasing the stiffness of the detachable clip 3126. The length of the detachable clip 3126 from the base end 3172 to the distal end 3174 is preferably approximately eight inches (8 in.).

Referring to FIG. 20, in operation, the detachable clip 3126 is assembled to the base power pole 3014 in substantially the same manner discussed in connection with the previous embodiments. Specifically, the removable cover (not shown) is first removed from the base power pole 3014. The removable cover (not shown) may be snapped or slid off of the base divider 3030, as should be understood by those skilled in the art. The elevated edges 3136 of the detachable clip 3126 may then be slid into the retaining ridges 3058 of the side portions 3050 of the base divider 3030, which is exposed due to the removal of the removable cover (not shown). The detachable clip 3126 is then secured to the base divider 3030 of the base power pole 3014 by the set screw 3134 or similar fastening means through the tapped hole 3176 proximate to the base end 3172.

The detachable end portion 3168 of the first cover 3068 of the power pole extender 3010 is then removed from the power pole extender 3010. The power pole extender 3010 is moved proximate to the base power pole 3014 so that power wiring (not shown) and/or communication wiring (not shown) may be snaked from the base power pole 3014 through the power pole extender 3010. Alternative, the power wiring (not shown) and/or communication wiring (not shown) may be snaked after connection of the power pole extender 3010 and the base power pole 3014. The power pole extender 3010 is then slid toward the base power pole 3014 with the second support sleeves 3086, shown in FIG. 18, sliding into the communication channel (not shown) of the base power pole 3014. Once the second cover 3070 and central divider 3072 of the power pole extender 3010 are flush with the communication cover 3028 and base divider 3030 of the base power pole 3014, another set screw 3134 may be engaged through the second tapped hole 3176 proximate to the distal end 3174 to secure the power pole extender 3010 to the base power pole 3014.

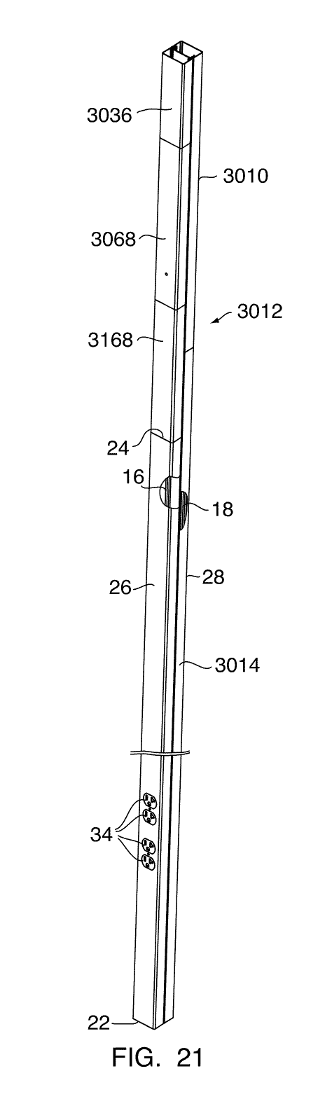

Referring to FIG. 21, the detachable end portion 3168 of the first cover 3068, which was removed from the power pole extender 3010 prior to connecting the power pole extender 3010 to the base power pole 3014, may be snapped back onto the exposed second end 3080 of the power pole extender 3010 and to the portion of the base power pole 3014 left exposed due to the removal of the removable cover 3036. The removable cover 3036 may then be snapped onto the exposed first end portion 3074, shown in FIG. 18, of the power pole extender 3010 to complete the installation.

Although the first cover 3068 of the power pole extender 3010 has been described as having a detachable end portion 3168, the first cover 3068 could instead be a single piece as described in connection with the previous embodiments. In this case, the entire first cover 3068 would be removed from the power pole extender 3010 to install the detachable clip 3126 as discussed above. Then, once the power pole extender 3010 is secured to the base power pole 3014 by the set screw 3134, the first cover 3068 may be snapped back into place on the power pole extender 3010 and may be snapped onto the portion of the base power pole 3014 left exposed due to the removal of the removable cover 3036. The removable cover 3036 may then be snapped onto the exposed first end portion 3074, shown in FIG. 18, of the power pole extender 3010 to complete the installation.

Additionally, although the detachable clip 3126 was described as being installed on the base divider 3030 prior to engagement of the power pole extender 3010 with the base power pole 3014, the detachable clip 3126 may instead be installed on the central divider 3072 of the power pole extender 3010 with set screw 3134 prior to engagement of the power pole extender 3010 with the base power pole 3014. Then, once the second cover 3070 and central divider 3072 of the power pole extender 3010 are flush with the communication cover 3028 and base divider 3030 of the base power pole 3014, another set screw 3134 may be engaged through the tapped hole 3176 proximate to the base end 3172 to secure the power pole extender 3010 to the base power pole 3014.

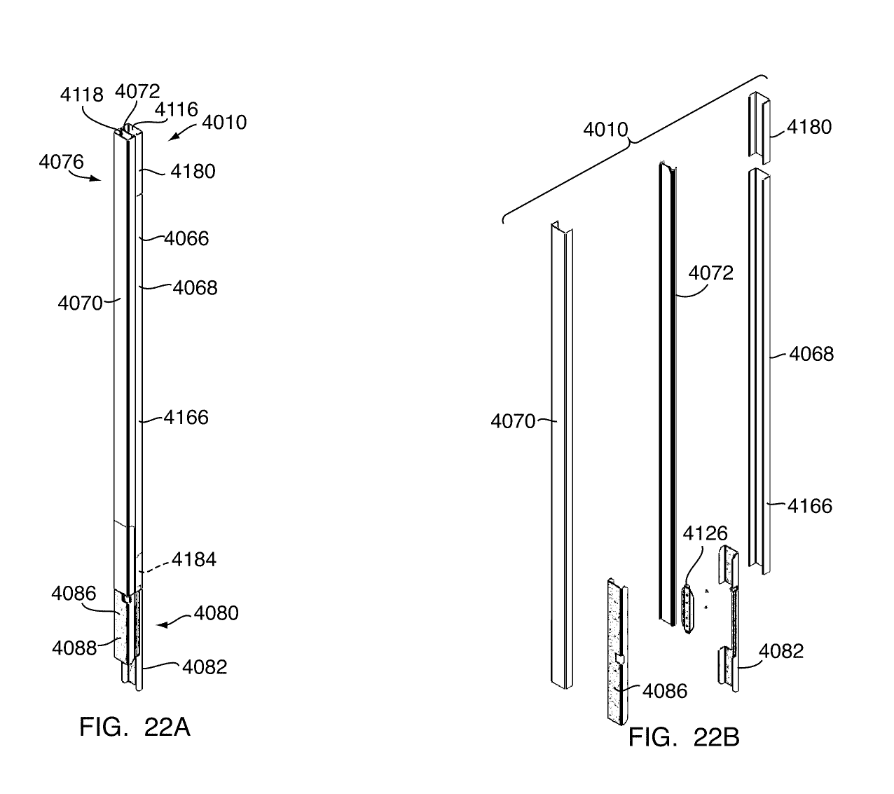

Referring to FIGS. 22A and 22B, another embodiment of the power pole extender 4010 includes housing 4066 having first cover 4068 and second cover 4070 connected to opposing sides of the central divider 4072 to define first channel 4116 and second channel 4118 in substantially the same manner as discussed above. The first cover 4068, second cover 4070 and central divider 4072 are all substantially the same length and extend adjacent to one another from first end 4076 to second end 4080. The first cover 4068 is divided into main body portion 4166 and a detachable cover 4180. The detachable cover 4180 is disposed at the first end 4076 of the power pole extender 4010 and, in some embodiments, may be approximately eight inches (8 in.) long and substantially the same as the removable cover 36, shown in FIG. 2, of the base power pole 14, shown in FIG. 2.

As in the previous embodiments, the power pole extender 4010 includes first support sleeve 4082 partially accommodated within the first cover 4068 and extending outwardly therefrom at the second end 4080. The power pole extender 4010 also includes second support sleeve 4086 partially accommodated within the second cover 4070 and extending outwardly therefrom at the second end 4080 to define the second support sleeve portion 4088. The power pole extender 4010 additionally includes detachable clip 4126 to facilitate attachment of the power pole extender 4010 to the base power pole 14, shown in FIG. 2.

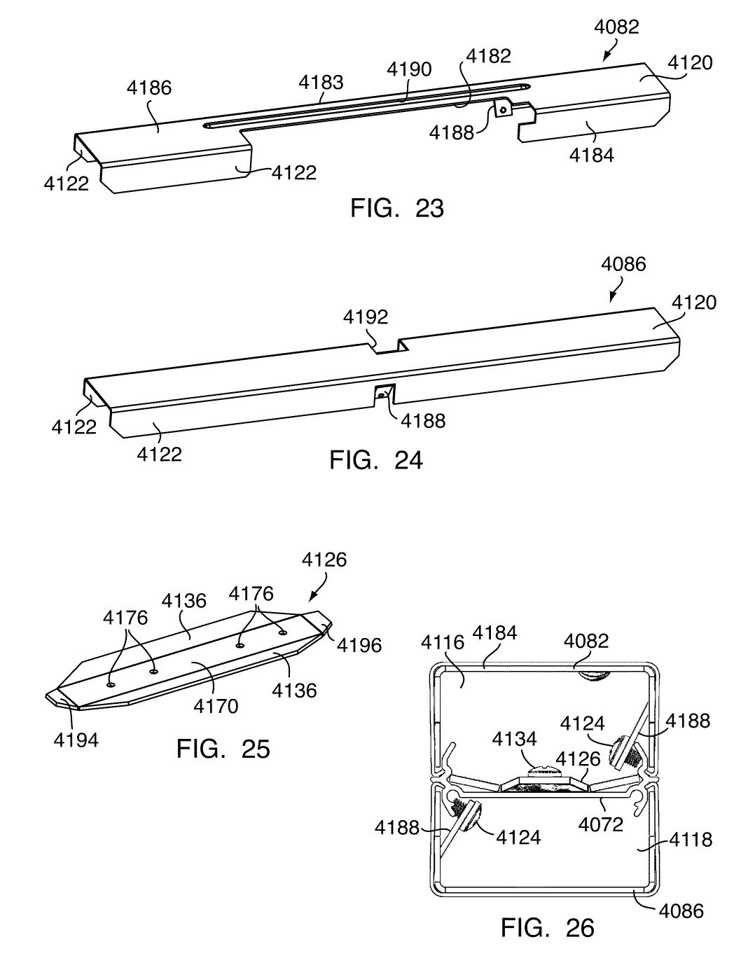

Referring to FIG. 23, the first support sleeve 4082 includes outer wall 4120 connected to substantially perpendicular side walls 4122. The support sleeve 4082 includes an attachment cutaway 4182 formed along a central portion 4183 of the first support sleeve 4082, thereby dividing the first support sleeve 4082 into an extender portion 4184 at one end and a base portion 4186 at the other end, with the central portion 4183 therebetween. The attachment cutaway 4182 may be formed in at least one side wall 4122 and at least a portion of the outer wall 4120 to provide accessibility to the detachable clip 4126, shown in FIG. 22B, as will be discussed in greater detail below. Each of the extender portion 4184 and the base portion 4186 includes outer wall 4120 connected to the substantially perpendicular side walls 4122 such that they may slidably engage the first channel 4116, shown in FIG. 22A, as will be discussed in greater detail below. The extender portion 4184 may include a screw flange 4188 formed in one side wall 4122 to facilitate attachment of the first support sleeve 4082 within the first channel 4116, shown in FIG. 22A. In some embodiments, the first support sleeve 4082 may also include a reinforcement member 4190, such as a rib or the like, extending along at least the length of the central portion 4183 to increase strength thereof. In some embodiments, the first support sleeve 4082 may be approximately eighteen inches (18 in.) long with each of the extender portion 4184 and the base portion 4186 extending for approximately five inches (5 in.) of the eighteen inches (18 in.) of length.

Referring to FIG. 24, the second support sleeve 4086 is substantially the same as those discussed in the various embodiments above and includes outer wall 4120 connected to two substantially perpendicular side walls 4122 for slidably engaging within the second channels 4118, shown in FIG. 22A. Like the first support sleeve 4082, shown in FIG. 23, the second support sleeve 4086 may also include a screw flange 4188 formed in one side wall 4122 to facilitate attachment of the second support sleeve 4082 within the second channel 4118, shown in FIG. 22A. The second support sleeve 4086 may also include a tool opening 4192 formed in the outer wall 4120 and/or the side wall 4122 opposite the screw flange 4188 to provide accessibility to the screw flange 4188 for fastening a screw 4124, shown in FIG. 26, therein. While the tool opening 4192 may be formed directly opposite the screw flange 4188, in some embodiments, the tool opening 4192 and the screw flange 4188 may be offset from one another along the length of the second support sleeve 4086 so as to maintain the strength of the second support sleeve 4086. In some embodiments, the second support sleeve 4086 may be approximately eighteen inches (18 in.) long with one edge of the screw flange 4188 formed at approximately the midpoint of the second support sleeve 4086.

Referring to FIG. 25, the detachable clip 4126 for connecting the power pole extender 4010, shown in FIG. 22A, to the base power pole 14, shown in FIG. 2, includes substantially flat central body portion 4170 flanked by elevated side edges 4136 for engaging the central divider 4072, shown in FIG. 22A, in substantially the same manner discussed above. The central body portion 4170 and the elevated edges 4136 extend from a first elevated end 4194 of the detachable clip 4126 to a second elevated end 4196 of the detachable clip 4126. The central body portion 4170 includes tapped holes 4176 along its length, with at least one tapped hole 4176 located proximate to the first elevated end 4194 and at least one tapped hole 4176 located proximate to the second elevated end 4196. In some embodiments, the length of the detachable clip 4126 may be approximately eight inches (8 in.) or less.

Referring back to FIG. 22A and to FIG. 26, the extender portion 4184 of the first support sleeve 4082 is disposed within the first channel 4116 and is secured therein by screw 4124, shown in FIG. 26, and screw flange 4188, shown in FIG. 26. Similarly, a portion of the second support sleeve 4086 is disposed within the second channel 4118 and is secured therein by screw 4124, shown in FIG. 26 passing through screw flange 4188, shown in FIG. 26. Additionally, the detachable clip 4126, shown in FIG. 26, is attached to the central divider 4072 by one or more set screw 4134, shown in FIG. 26, within the first channel 4116. As discussed in connection with the previous embodiments, the detachable clip 4126 extends outward from the central divider 4072 at the second end 4080 of the power pole extender 4010, shown in FIG. 22A.

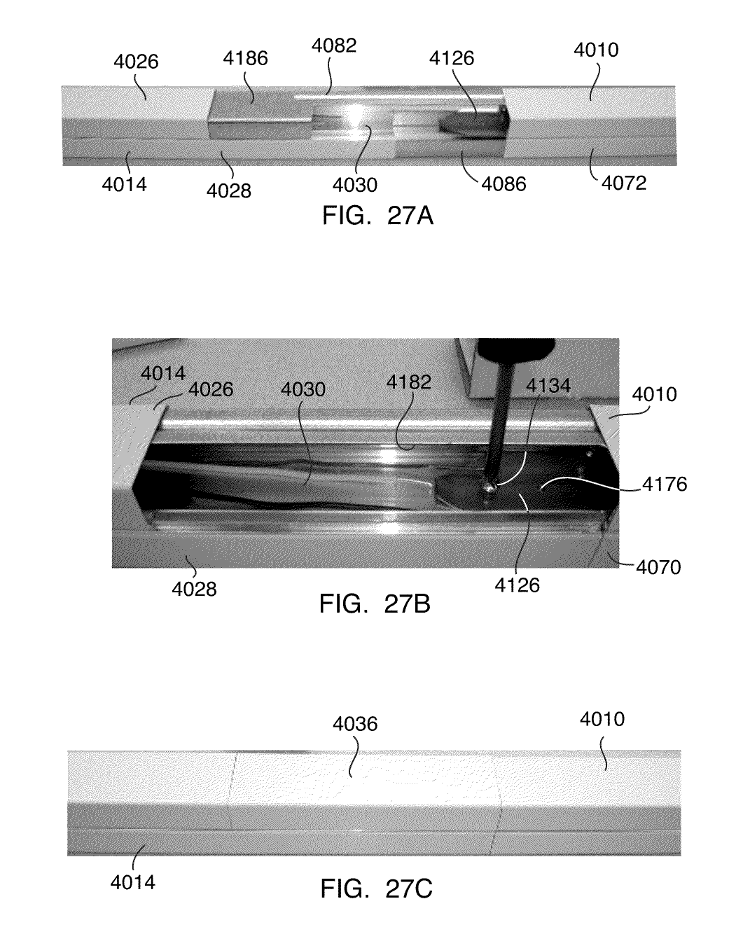

Referring to FIG. 27A, in operation, to install the power pole extender 4010 on the base power pole 4014 the removable cover 36, shown in FIG. 2, is first removed from the base power pole 4014 as discussed above in connection with FIG. 8. Power wiring 16, shown in FIG. 10, and/or communication wiring 18, shown in FIG. 10, may be snaked from the base power pole 4014 through the first and second channels 4116 and 4118 of power pole extender 4010, respectively, in substantially the same manner discussed above. Alternatively, in some embodiments, the base power pole 4014 and the power pole extender 4010 may be shipped together and may be prewired such that physical connection of the power pole extender 4010 to the base power pole 4014 is all that is required.

Once the wiring has been run, or if wiring is to occur after physical assembly, the power pole extender 4010 and the base power pole 4014 may be slid together with the base portion 4186 of the first support sleeve 4082 sliding into the power channel 62, shown in FIG. 3, of the base power pole 4014 and with the second support sleeve 4086 sliding into the communication channel 64, shown in FIG. 3, of the base power pole 4014.

Referring to FIG. 27B, the power pole extender 4010 and the base power pole 4014 are slidably engaged until the base portion 4186 is fully within the power cover 4026 of the base power pole 4014 and until the second cover 4070 and central divider 4072, shown in FIG. 22B, of the power pole extender 4010 are flush with the communication cover 4028 and the base divider 4030 of the base power pole 4014, respectively. As the power pole extender 4010 and the base power pole 4014 are slid together, the detachable clip 4126 slidably engages the base divider 4030. The attachment cutaway 4182 of the first support sleeve 4082 advantageously provides access to the detachable clip 4126 once the power pole extender 4010 is fully engaged with the base power pole 4014. Thus, once fully engaged, one or more set screws 4134 may be screwed through one or more tapped holes 4176 to secure the detachable clip 4126 to the base divider 4030, thereby securing the power pole extender 4010 to the base power pole 4014.

Referring to FIG. 27C, the removable cover 4036 may then be snapped back into place on the base power pole 4014 to cover the exposed detachable clip 4126, shown in FIG. 27B, and to complete installation of the power pole extender 4010 on the base power pole 4014.

One major advantage of the power pole extender 10, 1010, 2010, 3010 and 4010 is that it provides the flexibility to extend power poles in a large variety of installation projects. Thus, the power pole extender 10, 1010, 2010, 3010 and 4010 eliminates the need for custom fabrication of power poles at specific, exact heights and/or the need to cut the power poles to specific heights during installation.

Another advantage of the present invention is that the power pole extender 10, 3010 and 4010 may be formed to different lengths, for example, two feet (2 ft.) or five feet (5 ft), so that the power pole extenders 10, 3010 and 4010 may be shipped without exceeding the nine foot (9 ft.) maximum length shipping restriction of the United States Postal Service (USPS). Therefore, the power pole extender 10, 3010 and 4010 may be shipped via the USPS more quickly, with a lower rate of shipping damage, than conventional power poles, which must be freight shipped.

A further advantage of the present invention is that the base power pole 14, 3014 and 4014 may also be formed to lengths smaller than the nine foot (9 ft.) USPS shipping restriction, so that the base power pole 14, 3014 and 4014 may be shipped via the USPS. For example, the base power pole 14, 3014 may be formed to a length of eight feet (8 ft.). Thus, the present invention can accommodate a variety of different installation heights greater than nine feet (9 ft.), without exceeding the nine foot (9 ft.) USPS shipping maximum. Thus, the present invention entirely eliminates the need to freight ship power pole components.

Another advantage of the present invention is that it is compatible with existing power poles. Thus, the power pole extender 10, 3010, and 4010 may extend new base power poles 14, 3014 and 4014 for new installation projects and/or may be used to retrofit existing power poles.

Thus, the present invention increases power pole installation flexibility while reducing shipping costs associated with conventional power poles and without sacrificing the strength or safety of the power pole.

Although this invention has been shown and described with respect to the detailed embodiments thereof, it will be understood by those skilled in the art that various changes in form and detail thereof may be made without departing from the spirit and the scope of the invention. For example, although the power pole extender 10, 3010 and 4010 have been described as having separate first and second covers 68, 3068, 4068 and 70, 3070, 4070 attached to the central divider 72, 3072, 4072, the first and second covers 68, 3068, 4068 and 70, 3070, 4070 could be a single integral component, with the central divider 72, 3072, 4072 being inserted therein to form the first and second channels 116, 4116 and 118, 4118.

What is claimed is:

1. A power pole extender comprising:
a housing having a central divider separating a first channel within the housing from a second channel within the housing;
a first support sleeve partially disposed within the first channel and extending outwardly therefrom; and
a second support sleeve partially disposed within the second channel and extending outwardly therefrom.

2. The power pole extender according to claim 1, additionally comprising a locking element disposed on the central divider and a detachable clip, connectable to the locking element.

3. The power pole extender according to claim 2, wherein the locking element is a bolt.

4. The power pole extender according to claim 2, wherein the detachable clip includes a lock slot for engaging the locking element.

5. The power pole extender according to claim 4, wherein the locking element has a gumdrop shape with a conical side surface and the lock slot is a variable sized slot to substantially eliminate relative movement between the power pole extender and a base power pole when engaged.

6. The power pole extender according to claim 2, wherein the detachable clip includes elevated edges for slidably engaging a base divider of a base power pole.

7. The power pole extender according to claim 2, wherein the detachable clip includes a ramp that ensures that the detachable clip slides over the locking element.

8. The power pole extender according to claim 1, additionally comprising a lock slot formed in the central divider and a detachable clip, connectable to the lock slot.

9. The power pole extender according to claim 8, wherein the detachable clip includes a locking element capable of accommodation within the lock slot.

10. The power pole extender according to claim 9, wherein the locking element is a tab.

11. The power pole extender according to claim 1, wherein the housing includes a first cover and a second cover with the central divider interposed therebetween.

12. The power pole extender according to claim 11, wherein the first cover is offset from the second cover and the central divider to expose an end portion of the central divider.

13. The power pole extender according to claim 12, wherein the offset is approximately eight inches.

14. The power pole extender according to claim 12, wherein the exposed end portion of the central divider is connectable to a removable cover of a base power pole.

15. The power pole extender according to claim 1, additionally comprising screws securing the first and second support sleeves to the housing.

16. The power pole extender according to claim 1, additionally comprising a detachable clip attached to the central divider.

17. The power pole extender according to claim 16, wherein the detachable clip is partially disposed within the first channel and extends outwardly therefrom.

18. A power pole comprising:
a base power pole; and
at least one power pole extender connected to the end of the base power pole to form a first channel for power wiring and a second channel for communication wiring, the first and second channels extending substantially the entire length of the power pole.

19. The power pole according to claim 18, wherein the at least one power pole extender includes first and second support sleeves extending into the base power pole within the first and second channels.

20. The power pole according to claim 18, additionally comprising a detachable clip secured to the base power pole and engaging a locking element of the power pole extender.

21. The power pole according to claim 20, wherein the detachable clip is secured to a base divider of the base power pole and the locking element is attached to a central divider of the power pole extender.

22. The power pole according to claim 21, wherein the detachable clip includes an alignment edge substantially flush with a top edge of the base divider of the base power pole.

23. The power pole according to claim 18, additionally comprising at least one second power pole extender connected to the end of the first power pole extender.

24. The power pole according to claim 23, additionally comprising a detachable clip secured to the first power pole extender and engaging a locking element of the second power pole extender.

25. The power pole according to claim 18, additionally comprising a detachable clip secured to the at least one power pole extender and to the base power pole.

26. An extension for a power pole comprising:
a housing having a central divider separating a first channel within the housing from a second channel within the housing;
a locking element disposed on the central divider within the first channel; and
a detachable clip, connectable to a base power pole, for engaging the locking element.

27. The extension according to claim 26, wherein the detachable clip includes a lock slot for engaging the locking element.

28. The extension according to claim 26, wherein the detachable clip includes elevated edges for slidably engaging the base power pole.

29. The extension according to claim 26, wherein the detachable clip includes a ramp at a distal end that has a ramp height greater than a retaining height of the locking element.

30. A power pole extender comprising:
a housing having a central divider separating a first channel within the housing from a second channel within the housing; and
a detachable clip attached to the central divider and partially disposed within one of the first channel and second channel end extending outwardly therefrom.
